(19) United States
(12) Patent Application Publication
(10) Pub. No.: US 2025/0301943 A1
(43) Pub. Date: Oct. 2, 2025

(54) Curved Spreader Disk for Spreading Granular Material

(71) Applicant: Stinger Equipment, Inc., Buckner, KY (US)

(72) Inventor: David Michael Cook, Jekyll Island, GA (US)

(21) Appl. No.: 18/899,391

(22) Filed: Sep. 27, 2024

Related U.S. Application Data
(60) Provisional application No. 63/586,159, filed on Sep. 28, 2023.

(51) Int. Cl. A01C 17/00; A01C 15/00

(52) U.S. Cl. CPC A01C 17/001; A01C 15/006

(57) ABSTRACT

Implementations disclosed herein are directed to a curved spreader disk for spreading a granular material. In some implementations, the curved spreader disc may include: a concave curved disk with a plurality of fins radiating outward from a center of the curved disk. Each of the fins may includes a substantially straight inner area near to the center of the curved disk for catching granular material and a curved outer area to accelerate movement of the granular material. The substantially straight inner area may transition the granular material from a vertical movement to a horizontal movement.

### BACKGROUND OF THE INVENTION

Spreader disks are used for spreading granular material like fertilizer in the turf industry. Traditionally, spreader disks are normally made from plastic or stainless steel, predominately flat, and have 4 substantially straight vertical surfaces that sling the material from the center of the spread disk. Granular material is dropped proximate to the center of the spinning disk through a small opening in a hopper located just above the spinning disk. The hopper holds the material and as the material is released from the hopper, the spinning disk slings the material across the ground.

Since spreader disks are traditionally flat in nature, the material exits the disk in a predominately horizontal direction and the speed of the disk determines the distance the material is thrown. When the material reaches the ground, the material is still traveling in a mostly horizontal direction, so it tends to skip across the ground and not stop where it was intended. This becomes a problem when trying to spread fertilizer or weed control products next to flower beds or hard surfaces like sidewalks and driveways. Not only is the fertilizer thrown past where the operator intends, it often lands on hard surfaces like a driveway, road, or sidewalk. Once on the hard surface, the horizontal throwing nature of the material skips and rolls across the road, driveway, or sidewalk requiring additional cleanup of this unwanted material.

Since these traditional flat spread disks are only capable of slinging material in a horizontal direction, the width of the spread pattern is determined by both the speed of the disk and the height of the disk from the ground. For example, to spread material in a wide pattern, this requires a spreader disk to be higher from the ground, resulting in a high center of gravity for the spreader. This higher center of gravity makes a spreader more difficult to operate on hills.

Additionally, when material is released from the hopper onto the spreader disk, some of the material is spread excessively in a single area (e.g., to the side and direction of rotation of the disk). In conventional spreader disk designs, the four (4) fins or vanes in the center of the disk are vertical and radiate from the center of the spinning axis. Since these fins are relatively perpendicular to the material that is dropped onto the disk, a percentage of the material bounces off the top of the disk instead of sliding down along the face of the fins to be slung and spread as intended. The material that bounces off the top of the fin is thrown to the side and causes an uneven material spread pattern.

Thus, there is a need in the art for a spreader disk that more efficiently and accurately spreads material. Specifically, there is a need for a design that allows the spreader disk to be lower to the ground and still throw the intended width; a design that gives the operator more control on where the material lands for applying product in tight areas; and/or a design that spreads evenly side to side and doesn't have material bouncing off the top of the fin to collect to the side of the spread pattern.

The information included in this Background section of the specification, including any references cited herein and any description or discussion thereof, is included for technical reference purposes only and is not to be regarded subject matter by which the scope of the invention is to be bound.

### SUMMARY OF THE INVENTION

There is a need for an impeller disk that is capable of better control of both the direction and placement of granular material while spreading. The spreader disk shown and described herein improves both placement and a smoother transition of material from the vertical to the centrifugal slinging motion that delivers the material into a uniform arc on the ground.

The spreader disk shown and described herein is aimed, at least in part, at improving the exit direction of the material coming off the disk. Providing a greater upward direction from the normal horizontal direction allowed the material to land more softly and controllably on the ground. Spreading the material with an upward exit direction allows the material to engage the ground in a more vertical direction upon landing allowing the material to stop quicker and more accurately.

The spreader disk shown and described herein has an exit angle of 35 degrees which allows for better control of the placement of fertilizer than what is used in the industry today. Although illustrated with a 35-degree angle, this is not intended to be limiting, as the angle could range from about 10 to about 60 degrees.

The present application discloses one or more of the features recited in the appended claims and/or the following features which alone or in any combination, may comprise patentable subject matter.

In a first aspect, a curved spreader disk for spreading a granular material comprises: a concave curved disk; a plurality of fins radiating outward from a center of the curved disk, where each of the plurality of fins includes: a substantially straight inner area disposed proximate to the center of the curved disk for catching granular material; where the substantially straight inner area transitions the granular material from a vertical movement to a horizontal movement; and a curved outer area to accelerate movement of the granular material.

In some implementations, there are six fins radiating outward from the center of the curved disk. In some implementations, the plurality of fins radiating outward from the center of the curved disk catch the granular material at a catching angle for the granular material of between about 10 degrees to about 75 degrees. In some implementations, the catching angle is about 65-degrees.

In some implementations, the plurality of fins radiating outward from the center of the curved disk result in an exit angle for the granular material of about 10-degrees to about 60-degrees. In some implementations, the exit angle for the granular material is about 35-degrees. In some implementations, the exit angle allows the granular material to exit off an edge of disk with both a horizontal exit velocity and a vertical exit velocity.

In some implementations, the curved spreader disk further includes a motor to control a rotational speed of the curved spreader disk.

In another aspect, a curved spreader disk for spreading a granular material comprises: a concave curved disk; a plurality of fins radiating outward from a center of the curved disk catch the granular material at a catching angle for the granular material of between about 10 degrees to about 75 degrees, where each of the plurality of fins includes: a substantially straight inner area disposed proximate to the center of the curved disk for catching granular material; where the substantially straight inner area transitions the granular material from a vertical movement to a horizontal movement; a curved outer area to accelerate movement of the granular material; an exit angle for the granular material of about 10-degrees to about 60-degrees.

In some implementations, there are six fins radiating outward from the center of the curved disk. In some implementations, the catching angle is about 65-degrees. In some implementations, the exit angle for the granular material is about 35-degrees. In some implementations, the exit angle allows the granular material to exit off an edge of disk with both a horizontal exit velocity and a vertical exit velocity.

In some implementations, the curved spreader disk further includes a motor to control a rotational speed of the curved spreader disk.

### BRIEF DESCRIPTION OF THE DRAWINGS

In order that the embodiments may be better understood, embodiments of an applicator control user interface will now be described by way of examples. These embodiments are not to limit the scope of the claims as other embodiments of an curved spreader disk will become apparent to one having ordinary skill in the art upon reading the instant description. Non-limiting examples of the present embodiments are shown in figures wherein:

FIG. 1 is an isometric view of a curved spreader disk consistent with some embodiments described herein.

FIG. 2 is an isometric view of a traditional spreader disk.

FIG. 3 is a top view of the curved spreader disk of FIG. 1.

FIG. 4 is a top view of the traditional spreader disk of FIG. 2.

FIG. 5 illustrates a spread pattern of the traditional spreader disk of FIG. 2.

FIG. 6 illustrates a spread pattern of the curved spreader disk of FIG. 1.

FIG. 7 is a cross-sectional view of the curved spreader disk of FIG. 1.

FIG. 8 is a front view of a curved spreader disk spreading material consistent with some embodiments described herein.

FIG. 9 illustrates a traditional spreader disk installed on riding applicator with spreader.

FIG. 10 illustrates a curved spreader disk mounted to spreader motor consistent with some embodiments described herein.

FIG. 11 illustrates a curved spreader disk installed on a variable speed motor consistent with some embodiments described herein.

### DETAILED DESCRIPTION OF THE INVENTION

It is to be understood that a curved disk spreader is not limited in its application to the details of construction and the arrangement of components set forth in the following description or illustrated in the drawings. The described embodiments are capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment but may. Furthermore, the particular features, structures or characteristics may be combined in any suitable manner, as would be apparent to one of ordinary skill in the art from this disclosure, in one or more embodiments.

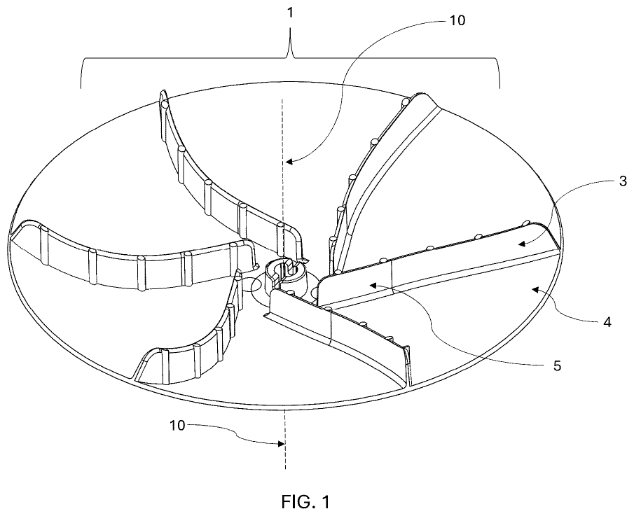

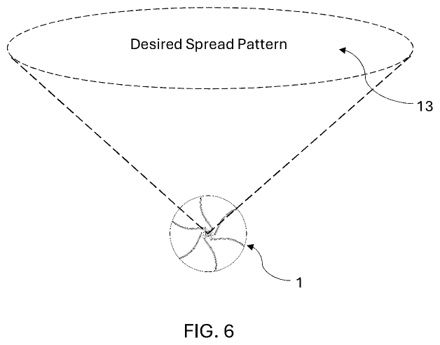

FIG. 1 shows an exemplary embodiment of a curved spreader disk 1. The curved spreader disk 1 has distinct features to improve spreading accuracy, controllability, and lower the overall center of gravity of the spreader. The curved spreader disk 1 has a generally concave or bowl shape, curving upward from a lower center point. For example, the embodiment illustrated in FIG. 1 features six (6) fins that radiate out from the center. The fins comprise two parts, an inner surface 5 on the fin that is proximate to the center of the disk, where material that is to be spread first contacts the spreader disk 1 and an outer area 3. The inner surface 5 is substantially straight and is designed to catch the material and transition the material that is falling onto the disk from a vertical motion to a horizontal radial motion. The outer area 3 of the fin is curved to accelerate the movement of the material from the surface where the material is captured to where the material exits the end of the fin. In some embodiments, the fin (include the inner area 5 and the outer area 3) is injection molded as a single piece. The bottom of the spread disk 4 is also curved to increase the launch angle of the material. For example, an increased launch angle may allow the disk to be placed lower to the ground for a lower center of gravity. A positive launch angle also allows material to be thrown further while also landing with a more vertical direction of travel so material stays where the operator intended (see FIGS. 6, 8 and 9). Although illustrated and described as having six fins, this is not intended to be limiting, the curved spreader disk described herein may, in some embodiments, include more or less fins (e.g., four or eight fins may also be used).

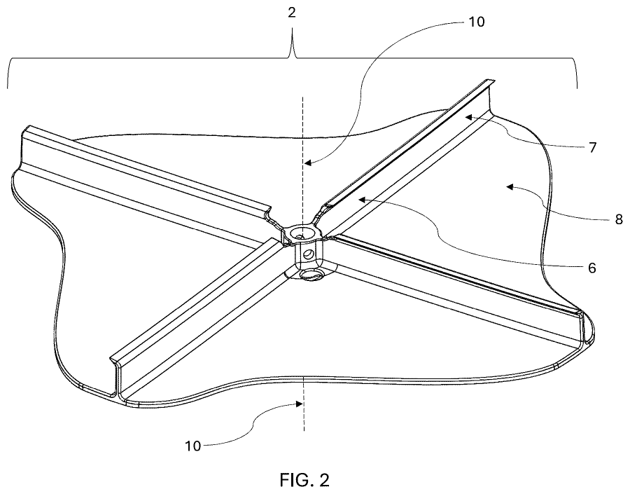

In contrast, FIG. 2 shows a traditional spread disk 2 with four (4) fins that radiate from the center of the disk for the intention of spreading granular material. In these conventional spreader disks, the area 6 of the fin closest to the center axis is parallel to the vertical spinning axis 10. The bottom surface 8 of the traditional spreader disk is flat. Accordingly, the end of the fin 7 is usually straight, as shown.

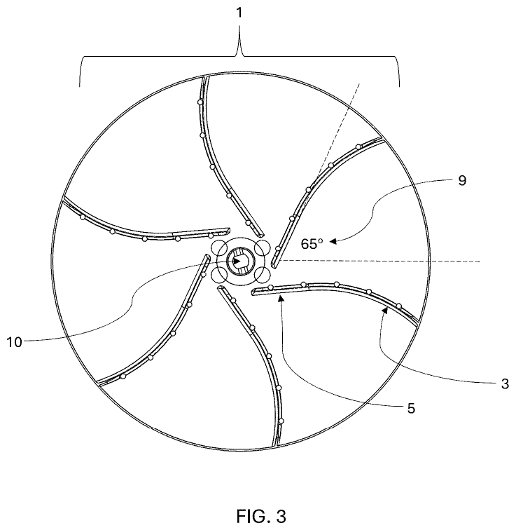

FIG. 3 is a top view of the embodiment of the curved spreader disk 1 illustrated in FIG. 1. In the center of the curved spreader disk 1, the fin 5 catches the material at an about 65-degree 9 angle instead of the material catching at a zero-degree angle that results from perpendicular fins. Catching the material at an about 65-degree angle allows for the material to be captured more softly instead of abruptly bounding off the spinning surface. FIG. 3 also shows how the material that is captured on the fins 5 is accelerated along the curved vertical fin 3 where it exits the edge of the spreader disk 1. Although described and illustrated as catching the material at an about 65-degree angle, this is not intended to be limiting. In some embodiments, this angle may range from about 10 degrees to about 75 degrees.

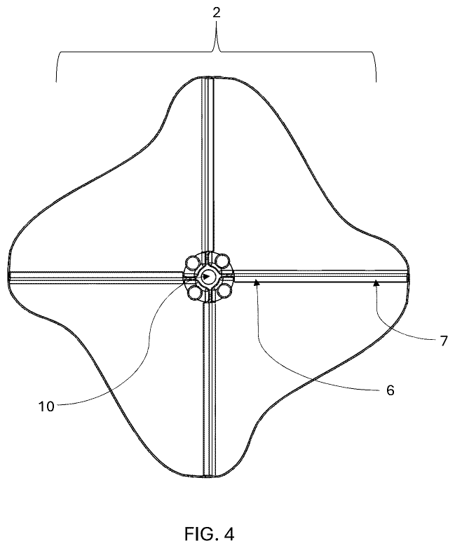

FIG. 4 is a top view of the traditional spreader disk 2 illustrated in FIG. 2. This view shows how the center area of the fin 6 is parallel to the vertical spinning axis 10 of rotation in the traditional spreader disk. Additionally, this view shows the remaining length of the fin 7 where material is accelerated along the fin 6 to exit the edge of the spreader disk 2.

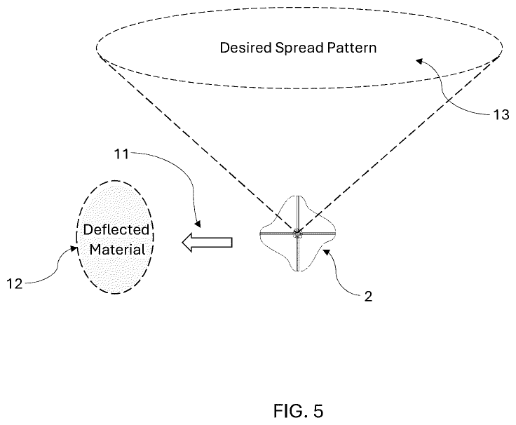

FIG. 5 is a top-down view of a traditional spreader disk 2 and illustrates how the traditional spreader disk spreads material. This diagram shows the spread pattern (not in motion) in order to demonstrate the unevenness of the spread pattern. Some spreaders with a traditional spreader disk will spread the majority of the material out front in an arc pattern 13; however, due to how the material transitions in the center of the disk 6 a portion of the falling material that is dispensed onto the disk (e.g., from a hopper) is abruptly bounced 11 off the spread disk directly to one side and lands on the ground 12 as shown. When spreading material in a back-and-forth method on a property as intended, the operator spreads material back to the center of their previous pass to provide a more even application in order to combat this unevenness. However, this ultimately results in doubles the amount of material thrown off target. This leads to areas of striping on a lawn where fertilizer is applied heavier and lighter between each pass of the spreader.

FIG. 6 shows a top-down view of the embodiment of the curved spreader disk 1 of FIG. 1. As in FIG. 5, FIG. 6 also shows the spread pattern (not in motion) in order to demonstrate the evenness of the spread pattern. As a result of the 65-degree angle 9 on the center of the fin 5 shown in FIG. 1, the material is more effectively captured onto the fin surface and accelerated along the edge of the fin 3 before exiting the edge of the spread disk. As a result of this shape and disposition of the material, the material dispensed out front in the area 13 as intended by the user. Material is not thrown directly to the side, as is seen in a traditional spreader disk.

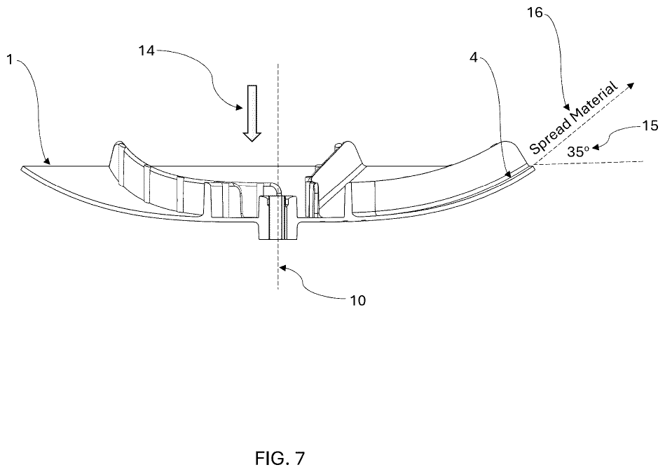

FIG. 7 shows a cross-section side view of the embodiment of the disclosed spread disk 1 of FIG. 1. This view shows where material is dispensed 14 from (e.g., a hopper) onto the spinning curved spreader disk 1. As the material transitions from a vertical falling motion to the horizontal spreading motion, the material is also accelerated in a vertical direction along the bottom 4 of the curved spreader disk 1. The material may be provided with an about 35-degree launch angle 15. Although this is not intended to be limiting, in some embodiments the launch angle may range from about 10-degrees to about 60-degrees. Material may exit off of the edge of disk 16 with both a horizontal and vertical exit velocity. This vertical exit velocity increases the distance the material can travel, and further allows the curved spreader disk 1 to be placed lower to the ground for an improved and lower center of gravity.

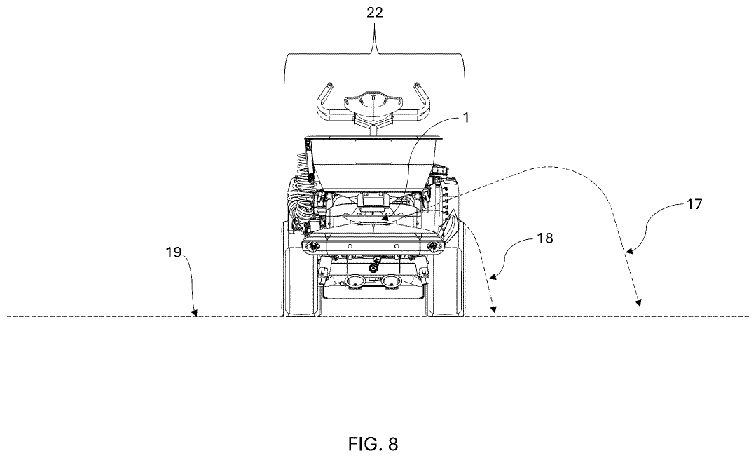

FIG. 8 shows an embodiment of a curved spreader disk 1 on a riding turf applicator 22. With the increased launch angle (e.g., about 35-degrees) described herein, the material spreads more accurately. Where the curved spreader disk 1 spinning faster, the material trajectory 17 is spread in a wide pattern. In contrast, where the curved spreader disk 1 is spinning slower, the material trajectory 18 is spread in a narrower pattern. In both examples, the material exits the curved spreader disk 1 in a vertical direction so that when the material encounters the ground 19, the material travels in a predominantly downward motion. The result of this predominantly downward movement is that the material lands and stays in the area the operator intended (e.g., the material doesn't “skip”). Additionally, with the increased launch angle 15 that the curved spreader disk 1 allows, the material can bespread in a narrower pattern than a traditional spread disk 2 allows because it is able to spread material just over the tire and fall to the ground. Accordingly, in some embodiments, the curved spreader disk 1 spread pattern may be just wider (for example six to twelve inches) than the width of wheel based on the machine on which the curved spreader disk 1 is mounted.

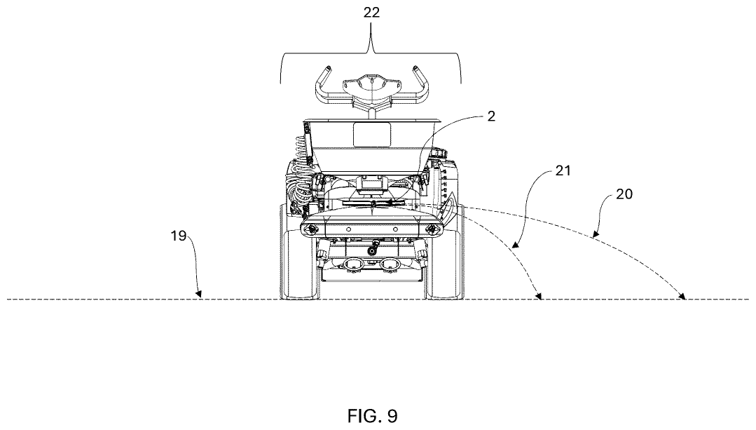

FIG. 9 shows the same riding turf applicator 22 with a traditional spread disk 2. As in FIG. 8, the traditional spread disk can spin fast or slow resulting in a wide material trajectory 20 or narrow trajectory 21 as shown. However, the traditional spreader disk 2 must spin much faster to achieve the same spread width as the curved spreader disk 1, this is a result of the difference in launch angles. Additionally, when the material encounters the ground, the material being launched from the traditional spreader disk 2 has a much larger horizontal velocity component as compared to the curved spreader disk 1 example in FIG. 8. This horizontal velocity results in the material skipping and bouncing along the ground or hard surfaces, and material that is spread inaccurately and off target (and ultimately additional clean up). Additionally, since the traditional spread disk 2 must spin faster to achieve the same spread width, the excess material to the side (see FIG. 5) is exasperated, resulting in even more material that is abruptly bounced 11 off the traditional spread disk directly to one side landing on the ground 12 as shown.

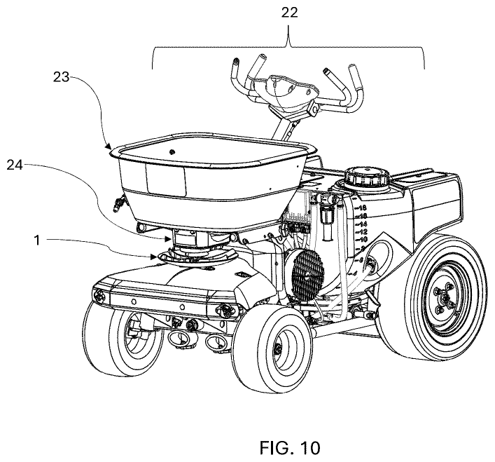

FIG. 10 shows an isometric view of an embodiment of the curved spreader disk 1 on a riding turf applicator 22. In this illustration, the material hopper 23 is mounted above the curved spreader disk 1 and the dispensing mechanism 24 for dispensing the granular material from the hopper and onto the curved spreader disk 1.

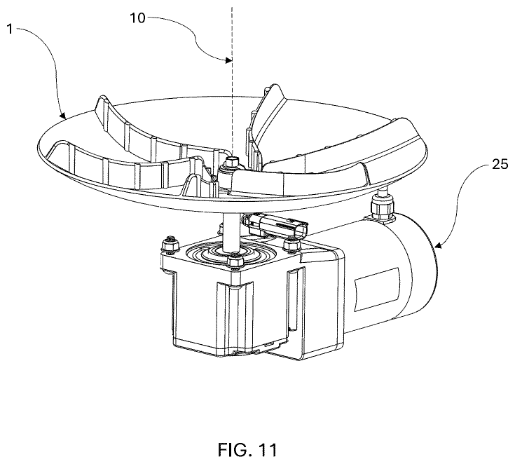

FIG. 11 shows an embodiment of the curved spreader disk 1 installed on a variable speed motor 25. The variable speed motor 25 allows for control of the rotational speed of the curved spreader disk 1. Control of the rotational speed results in control of the spreading width of the curved spreader disc 1. The electric motor can change speed to achieve the desired spread width of the operator. In other embodiments, the control of the rotational speed of the curved spreader disk may be through a belt driver connected to a motor or engine. In still other embodiments, the rotational speed of the curved spreader disk may be controlled through a hydraulic motor directly coupled to the curved spreader disk.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

I claim:

1. A curved spreader disk for spreading a granular material, comprising:
a concave curved disk;
a plurality of fins radiating outward from a center of the curved disk, wherein each of the plurality of fins includes:
a substantially straight inner area disposed proximate to the center of the curved disk for catching granular material;
wherein the substantially straight inner area transitions the granular material from a vertical movement to a horizontal movement; and
a curved outer area to accelerate movement of the granular material.

2. The curved spreader disk of claim 1, wherein the plurality of fins radiating outward from the center of the curved disk is six fins.

3. The curved spreader disk of claim 1, wherein the plurality of fins radiating outward from the center of the curved disk catch the granular material at a catching angle for the granular material of between about 10 degrees to about 75 degrees.

4. The curved spreader disk of claim 3, wherein the catching angle is about 65-degrees.

5. The curved spreader disk of claim 1, wherein the plurality of fins radiating outward from the center of the curved disk result in an exit angle for the granular material of about 10-degrees to about 60-degrees.

6. The curved spreader disk of claim 5, wherein the exit angle for the granular material is about 35-degrees.

7. The curved spreader disk of claim 5, wherein the exit angle allows the granular material to exit off an edge of disk with both a horizontal exit velocity and a vertical exit velocity.

8. The curved spreader disk of claim 1 further includes a motor to control a rotational speed of the curved spreader disk.

9. A curved spreader disk for spreading a granular material, comprising:
a concave curved disk;
a plurality of fins radiating outward from a center of the curved disk catch the granular material at a catching angle for the granular material of between about 10 degrees to about 75 degrees, wherein each of the plurality of fins includes:
a substantially straight inner area disposed proximate to the center of the curved disk for catching granular material;
wherein the substantially straight inner area transitions the granular material from a vertical movement to a horizontal movement;
a curved outer area to accelerate movement of the granular material;
an exit angle for the granular material of about 10-degrees to about 60-degrees.

10. The curved spreader disk of claim 9, wherein the plurality of fins radiating outward from the center of the curved disk is six fins.

11. The curved spreader disk of claim 9, wherein the catching angle is about 65-degrees.

12. The curved spreader disk of claim 9, wherein the exit angle for the granular material is about 35-degrees.

13. The curved spreader disk of claim 9, wherein the exit angle allows the granular material to exit off an edge of disk with both a horizontal exit velocity and a vertical exit velocity.

14. The curved spreader disk of claim 9 further includes a motor to control a rotational speed of the curved spreader disk.
